(19) United States
(12) Patent Application Publication
(10) Pub. No.: US 2024/0026256 A1
(43) Pub. Date: Jan. 25, 2024

(54) METHOD AND APPARATUS FOR AGING AN ALCOHOLIC BEVERAGE

(71) Applicant: Brian T Bolton, Lawrenceville, GA (US)

(72) Inventor: Brian T Bolton, Lawrenceville, GA (US)

(21) Appl. No.: 18/375,634

(22) Filed: Oct. 2, 2023

Related U.S. Application Data
(63) Continuation-in-part of application No. 17/207,702, filed on Mar. 21, 2021.

(51) Int. Cl. C12H 1/16; C12H 1/22; C12G 3/07

(52) U.S. Cl. CPC C12H 1/16; C12H 1/22; C12G 3/07

(57) ABSTRACT

A system and method for aging an alcoholic beverage, having a first housing, a second housing holding a liquid therein, the second housing having a wooden wall and positioned inside the first housing, and a gas transfer system fluidly coupled to the interior of the first housing, the gas transfer system executing a method, the method including (A) execute a complete pressurization cycle, the complete pressurization cycle comprising (i) causing a gas within the gas transfer system to pressurize the interior of the first housing to a first pressure for a first period of time, and, (ii) after the first period of time, causing the gas to pressurize the interior of the first housing to a second pressure less than the first pressure for a second period of time; and (B) repeat the complete pressurization cycle a plurality of times.

### TECHNICAL FIELD

Embodiments disclosed herein are related to aging an alcoholic beverage.

### BACKGROUND

Historically, alcoholic beverages have been “aged” in barrels, such as wooden barrels, such as, for example, oak barrels, until the beverages acquire a desired alcohol content and flavor, taste, or aroma profile. White Oak and European Oak are the preferred species of wood, because their cellular structures create an impervious barrier, minimizing leakage of the distilled spirit or wine from the barrel.

The species of oak the barrel is constructed from is dependent on the geography and the regulation of the distilled spirit. For example, in the United States, The Federal Standards of Identity for Distilled Spirits require bourbon to be aged in new charred white oak barrels. The French Appellation D′origine Controlee require Cognac to be aged in French oak barrels. The Scotch Whiskey Regulations 2009 require Scotch whiskey to be aged in new or used oak casks. There is no regulation for the species of wood used for a wine barrel.

Barrels are constructed of a number of staves—narrow strips of wood positioned to form the sides of the barrels. Staves are typically cut in a desired shape from seasoned oak. The standard dimensions of a stave for a 53 gallon whiskey barrel is 36 in. length, and 1½ in. depth. There are 32 to 35 staves used in the construction of a whiskey barrel. The standard dimensions of a stave for a 225 liter Bordeaux barrel is 37.4 in length and 22 mm (0.866 in) depth. The actual depth the barrel manufacturer planes the stave to is determined by the individual distillery's or winery's specifications. The depth of the stave determines the amount of oxygen transmission and the profile of the distilled spirit or wine. The size of the barrel determines its interior surface area and volume.

The interior surface area of the barrel and the volume of distilled spirit or wine have a specific percentage. A hole is drilled in one stave for filling, extracting from, and emptying the barrel. During construction, the staves are aligned lengthwise, bent under pressure by a cable, and bound by two steel hoops at the midsection. For a distilled spirit barrel. the interior of the entire barrel may be heat treated (e.g., either toasted or charred).

Char levels of 1, 2, 3, or 4 are the industry standards. The char levels impart various nuanced flavors to the distilled spirit. The time the barrel is allowed to burn determines the level of char. A wine barrel may be toasted. Toast levels of heavy, medium, or light are the industry standards. The top and bottom of the barrel have a wooden, round, flat head also of oak. The top and bottom of the barrel is bent under pressure to seat the top and bottom head in the notches of the staves. Both ends are bound by steel hoops. The barrel is filled with a distilled spirit or wine and the barrel hole is sealed with a bung.

Barrels are often stored in a warehouse on their sides in ricks, on pallets, or standing upright on the ground, which allows for airflow throughout the aging and maturation process in the warehouses. The warehouse may not be climate controlled; therefore, changes in temperature affect the movement of the distilled spirit or wine into and out of the porous structures of the wood.

For a whiskey barrel, the demarcation of penetration of the distilled spirit into the stave is commonly referred to as the red line. At various stages of aging, the bung may be removed by the distiller or vintner and a small sample of the distilled spirit or wine extracted and analyzed for quality and taste.

The length of time a distilled spirit is to be aged is dependent on the regions' regulations. For example, The Federal Standards of Identity for Distilled Spirits require whiskey to be aged for a minimum of two years. The French Appellation D′origine Controlee require Cognac to be aged for a minimum of two years. The Scotch Whiskey Regulations 2009 require Scotch whiskey to be aged for a minimum of three years. The length of time a wine is to be aged in a barrel is not regulated, however typical aging times is 6 to 30 months, shorter for whites and longer for reds.

In the warehouse, the oak barrel is exposed to an average barometric high and barometric low given the location of the warehouse during any 12 month period. An example is a high and low of 14.6 psi and 13.9 psi respectively. The differential pressure of the internal pressures of the barrel and the external atmospheric pressures creates a pressure gradient force and allows for the distilled spirit or wine to penetrate the wood at the internal surface of the wood barrel, and allows for the air to penetrate the external surface of the wood barrel and evacuate the distilled spirit or wine from the wood.

In the United States, the “Angels Share” is a common distilled spirits industry euphemistic term used to describe the evaporation that occurs during the aging process of distilled spirits. Evaporation rates vary by distillery or winery and are variable from barrel to barrel. The average evaporation rate per barrel according to some distilleries and wineries is 5% per year. The specific cause of the evaporation is unknown; however, due to the evaporation of the distilled spirit over an aging period of 7 years, the surface area to volume ratio decreases from 33% to 25%.

Under historic aging conditions, the surface area to volume is reduced from 33% to 21% due to evaporation, during a seven year aging period for a distilled spirit. For example, at the end of a seven year aging period of a distilled spirit, the estimated reduction of a barrel's volume due to evaporation goes from 53 gallons in the first year to 35.45 gallons at the end of the 7th year.

The hardness of a species of wood is measured by a Janka scale. The Janka measure is the force required to embed a 7/16 in diameter steel ball into the wood to a depth of half the balls diameter. The Janka Hardness of White Oak is 1,350 pounds-force. Therefore, it takes 192.85 pounds-force to embed a steel ball 1/32 inches into white oak.

Extracting phenols from a wood barrel that contains distilled spirits:

The average density of a distilled spirit is 54.2 lb/ft3. The density of steel is 490 lb/ft3. The factor of distilled spirit to steel is 0.1106. Penetration of the distilled spirit into the wood layer is, by published research stated to range from 1 mm (0.0394 in) to 2 mm (0.0788 in). Penetration of the wine into the wood is, by published research, to range from 3 mm (0.1182 in) to 4 mm (0.1576 in). It takes 10.24 psi to drive the distilled spirit 0.0788 in. into and out of white oak.

The depth of the charcoal layer is determined by the barrel manufacture's level of char of the barrel (char 1, char 2, char 3, char 4), according to the specifications of the distillery customer. Charcoal layer depths range from ⅛ in to ¼ in. The most common char is #3 with a char depth of 3/16 in (0.1875). The density of charcoal is 12.985 lb/ft3. The density of white oak is 49.27 lb/ft3. The factor of charcoal to white oak is 0.263. A pressure of 6.40 psi will drive a distilled spirit 0.1875 in. into the charcoal layer.

The interior girth of a 53 gallon oak barrel is 23.5 in diameter. The density of the distilled spirit is 54.2 lb/ft3. The pressure of the distilled spirit on the interior wall of the wood barrel is 15.33 psi. That pressure drives the distilled spirit 0.1875 in. into the charcoal layer and 0.0687 in. into the wood layer.

During a 12 month period, according to climatic data there are 1,300 iterations of the barometric pressure reaching a high. The mean time of the duration of the barometric low to barometric high iterations is 01:54:00 (hh:mm:ss). There are 1,300 iterations of the barometric pressure reaching a low. The mean time of the duration of the barometric high to barometric low iterations is 02:00:00. Therefore, there are 1,300 cycles in the 12 month period. The total time of active barometric change is 5,070 hours. There are 8,760 hours in a calendar year. Therefore, there are 8,760-5,070=3,690 hours when there is no barometric activity, a barometric rest. The number of iterations of no barometric change is 11,120. The time of barometric rest 3,690/11,120 cycles is 00:19:54. At this time of barometric rest the distilled spirit attains a state of hydrostatic equilibrium. The total cycle time is 04:48:00.

Atmospheric air has a composition of Nitrogen 78.08%, Oxygen 20.95%. and Other gasses 0.97%. Replacing the atmospheric air in the cavity with oxygen yields an increase in the composition of oxygen by 79.05%. This factor improves the oxygenation processes of the wood and the distilled spirit or wine. The oxygenation factor then reduces the barometric low to high cycle time from 01:54:00 to 00:23:53. The oxygenation factor reduces the barometric high to low cycle time from 02:00:00 to 00:25:08. The oxygenation factor reduces the barometric rest from 00:19:54 to 00:04:10. Application of the oxygen factor may reduce the cycle time from 04:48:00 to 00:53:11. Application of the oxygenation factor may reduce the one year equivalent process from 365 days to 48.03 days.

It is desirable, however, to reduce the loss to evaporation and/or to reduce the time required to age the alcoholic beverage. There thus remains a need for an improved method of aging an alcoholic beverage and/or other new and innovative inventions.

### SUMMARY

An exemplary system for aging an alcoholic beverage includes a first housing having an interior and an exterior; a second housing holding a liquid therein, the second housing having a wooden wall and positioned inside the first housing; and a gas transfer system fluidly coupled to the interior of the first housing. The gas transfer system has a controller comprising instructions that, when executed by one or more processors, cause the gas transfer system to execute a method. The method includes: (A) execute a complete pressurization cycle, the complete pressurization cycle including (i) causing a gas within the gas transfer system to pressurize the interior of the first housing to a first pressure for a first period of time, and, (ii) after the first period of time, causing the gas to pressurize the interior of the first housing to a second pressure less than the first pressure for a second period of time. The method also includes (B) repeat the complete pressurization cycle a plurality of times. The first pressure is 15.7 psi or less. The gas includes at least 21.1 percent oxygen by volume. The second pressure is at least 4 psi less than the first pressure. With the system, the liquid is aged into an alcoholic beverage.

An exemplary method of aging an alcoholic beverage includes placing a wooden barrel containing a liquid inside a chamber having a gas therein, and causing the gas to undergo a complete pressurization cycle. The complete pressurization cycle includes a first pressure for a first period of time, and, after the first period of time, a second pressure less than the first pressure for a second period of time. The exemplary method includes causing the gas to repeat the complete pressurization cycle a plurality of times. The first pressure is 15.7 psi or less. The gas comprises at least 21.1 percent oxygen by volume. The second pressure is at 4 psi less than the first pressure. The liquid is aged into a desired alcoholic beverage in a period of time that is at least 50% less than a time prescribed by The Federal Standards of Identity for Distilled Spirits for the desired alcoholic beverage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a schematic of an exemplary system; and

FIG. 2 is a flowchart of an exemplary method.

### DETAILED DESCRIPTION

As previously stated herein, the making of alcoholic beverages historically requires a lengthy aging process, which also results in significant evaporation of the product. Embodiments described herein significantly reduce the aging process and evaporation loss and improve methods for extracting phenols from a wood barrel. Embodiments disclosed herein retain the construct, structure, properties, and integrity of a wood barrel, and may allow for the input, control, adjustment, and monitoring the values of high pressure, low pressure, cycle time, rest time, and number of cycles of the process performed so that the final alcoholic beverage may achieve the desirable color, flavor, aroma, taste, and body of a traditionally distilled alcoholic beverage.

Some embodiments disclosed herein reduce the amount of fluid lost to evaporation. Some embodiments reduce the number of pressurization cycles required to complete the aging process, and may reduce a seven year aging period for a standard 53 gallon barrel containing a distilled spirit to 71.45 days. Some embodiments reduce a one year aging period for a standard 225 liter barrel containing wine to 10.19 days.

Some embodiments disclosed herein reduce the surface area to volume ratio to 32% in 337 days. In some embodiments herein, at the end of a 337 day process, the barrel volume reduces from 53 gallons to only 51.35 gallons. Put another way, some embodiments prevent the estimated loss of 15.9 gallons of a distilled spirit.

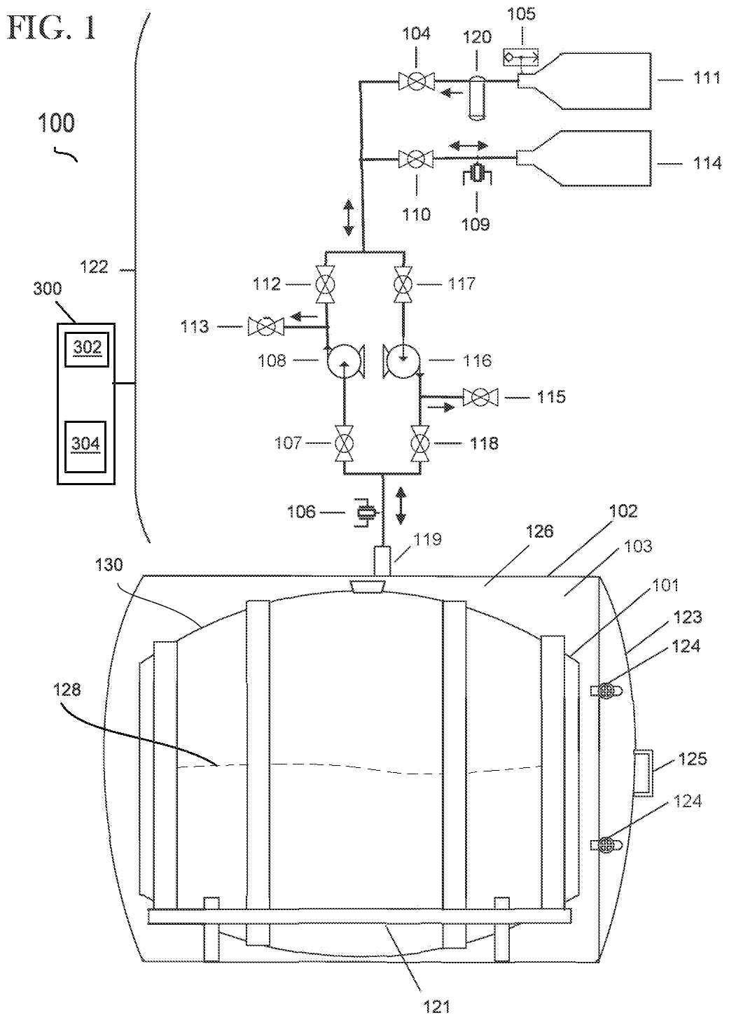

Turning now to FIG. 1, details of embodiments are described herein.

FIG. 1 is a schematic of an exemplary system 100 for aging an alcoholic beverage. The system 100 may have a first housing 102 having an interior 103 and an exterior. The housing 102 may be any container, chamber, or other suitable airtight facility. Inside the first housing 102 is a second housing 101 holding a liquid 128 therein, the second housing 101 may have a wooden wall 130. The second housing 101 may be a barrel having a plurality of staves held together by one or more metallic components such as a metallic band.

Continuing with FIG. 1, the system 100 may have a gas transfer system 122 fluidly coupled to the interior 103 of the first housing 102, the gas transfer system 122 having a controller 300 comprising instructions that, when executed by one or more processors 302, cause the gas transfer system 122 to execute a method 200.

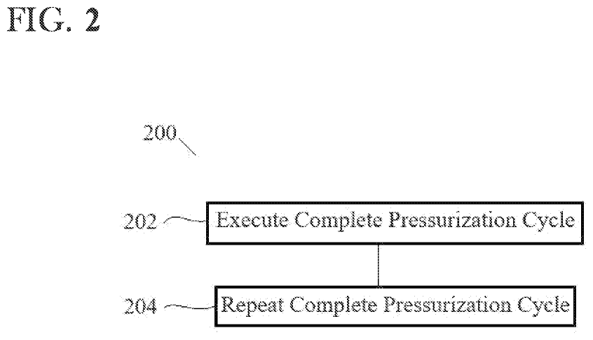

With brief reference to FIG. 2 in combination with FIG. 1, the method 200 may include: executing a complete pressurization cycle 202, and repeating the complete pressurization cycle a plurality of times 204.

The complete pressurization cycle 202 may include the steps of (i) causing a gas 126 within the gas transfer system 122 to pressurize the interior 103 of the first housing 102 to a first pressure for a first period of time, and, (ii) after the first period of time, causing the gas 126 to pressurize the interior 103 of the first housing 102 to a second pressure less than the first pressure for a second period of time. The second pressure may be at least 4 psi less than the first pressure.

In some embodiments, the second pressure is at least 10 psi less than the first pressure.

In some embodiments, the second pressure is about 0 psig.

In some embodiments, the complete pressurization cycle may include a third period of time between the first and second periods of time, wherein the first pressure is maintained at a substantially constant level. The third period of time may be 30 minutes or less. In some embodiments, the third period of time is 20 minutes or less.

In some embodiments, the complete pressurization cycle may include a fourth period of time after the second period of time, wherein the second pressure is maintained at a substantially constant level. The fourth period of time may be 10 minutes or less. In some embodiments, the fourth period of time is 6 minutes or less.

Those skilled in the art will recognize that, although the third period of time and fourth period of time are described as such, some embodiments may include the fourth period of time but not the third period of time, and vice versa. That is, these numerical designations are used merely to identify points in the pressurization cycle.

The first pressure may be 15.7 psi or less, or may be selected to cause the liquid 128 to penetrate the wooden wall of the second housing 101 a first preselected depth.

The gas 126 may comprise at least 21.1 percent or at least 30 percent oxygen by volume. The gas 126 may comprise at least 50 percent oxygen by volume. The benefit of using a gas 126 having an oxygen content greater than ambient air is that oxygen is an electronegative element; it attracts bonded electrons present in the saturated wood 130 and, in turn, creates compounds present in an aged distilled spirit. The amount of oxygen present in the system greater than ambient air yields greater oxygenation processes.

The second pressure may be at least 0 psi. The second pressure may be between 4 psi and 12 psi less than the first pressure.

In executing the method 200 using the system 100, the liquid 128 inside the second housing 101 may be aged into an alcoholic beverage.

In some embodiments, a portion of the wooden wall 130 is charred on an interior side thereof.

In some embodiments, the first pressure is 12 psi or less, or 10 psi or less, or 8 psi or less, or 7 psi or less.

In some embodiments, the second pressure is between 10 psi and 11 psi less than the first pressure. In some embodiments, the second pressure is between 4 psi and 12 psi less than the first pressure.

In some embodiments, the gas 126 comprises at least 50 percent oxygen gas by volume. In some embodiments, the gas 126 comprises at least 70 percent oxygen gas by volume. In some embodiments. the gas 126 comprises at least 90 percent oxygen gas by volume. In some embodiments, the gas 126 comprises at least 95 percent oxygen gas by volume. In some embodiments, the gas 126 comprises substantially 100 percent oxygen gas by volume. For the purpose of this document, the term “substantially 100 percent” shall be understood to mean as close to 100 percent as is reasonably practicable in manufacturing conditions at the time of manufacture.

The gas transfer system 122 may have at least one gas reservoir 114 and at least one valve 107, 118, 112, 117, 104, 110 responsive to the controller 300.

The system 100 may include a user interface 304 to allow a user to input certain variables for the controller 300. For example, the user may select a wood species and/or a wood hardness, such as a Janka rating, for the second housing 101, which may be referenced herein as a barrel, and/or the user may select a targeted distilled spirit, e.g. wine, whiskey, etc. The method 200 may include, optionally, responsive to a user input indicative of a wood species, determine the first pressure and the second pressure, wherein the first pressure and the second pressure are selected based on the wood species elected.

In some embodiments, the first period of time is between 12 minutes and 30 minutes; and the second period of time is between 2 minutes and 10 minutes.

In some embodiments, the complete pressurization cycle is repeated at least 1,300 times. In some embodiments, the complete pressurization cycle is repeated at least 1,300 times in 4 months or less. In some embodiments, the complete pressurization cycle is repeated at least 50,000 times in 9 years or less. In some embodiments, the complete pressurization cycle is repeated 30,000 times.

In some embodiments, the complete pressurization cycle is completed in less than 2 hours. In some embodiments, the complete pressurization cycle is completed in less than 90 minutes. In some embodiments, the complete pressurization cycle is completed in no less than 1 hour. Those skilled in the art will recognize that, cycling between the first period of time and the second period of time requires a rate of pressure change to be selected so as to not cause the second housing 101 to burst as a result of the rate being too fast.

Embodiments herein include a method of aging an alcoholic beverage. The method may include placing a wooden barrel containing a liquid inside a chamber having a gas therein; causing the gas to undergo a complete pressurization cycle, the complete pressurization cycle comprising (i) a first pressure for a first period of time, and, (ii) after the first period of time, a second pressure less than the first pressure for a second period of time. The method may include causing the gas to repeat the complete pressurization cycle a plurality of times, whereby the liquid is aged into a desired alcoholic beverage in a period of time that is at least 50% less than a time prescribed by The Federal Standards of Identity for Distilled Spirits for the desired alcoholic beverage. In some embodiments, the liquid is aged into a desired alcoholic beverage in a period of time that is at least 75% less than the time prescribed by The Federal Standards of Identity for Distilled Spirits for the desired alcoholic beverage.

The present invention relates to a method and apparatus for extracting phenols from a wood barrel. The invention may reduce the 7 year period of a distilled spirit to 337 days, thereby reducing the evaporation and the surface area to volume ratio to 32%. Some embodiments' improvement of surface area to volume ratio is 78.7%.

The density of oxygen is 0.0892 lb/ft3. The density of the distilled spirit is 54.2 lb/ft3.

The factor of oxygen to distilled spirit is 0.0016. A pressure of 0.25 psi will drive oxygen 1.2438 in. into the wood, to the point of interchange of the gas and distilled spirit. A pressure of 8.93 psi will drive the distilled spirit 0.0687 in. into the wood, to the point of interchange of the wood and charcoal layer. Reducing the pressure of 10.24 psi allows the distilled spirit to penetrate 0.0788 in. into the wood. An increase of pressure of 10.24 psi drives the distilled spirit 0.0788 in. to the interchange of the wood and charcoal layer.

The method and apparatus' alteration of the pressure of the cavity by 10.24 psi by a prescribed number of cycles achieves the extraction of the phenols from the wood barrel containing a distilled spirit.

Extracting phenols from a wood barrel that contains wine:

The average density of a wine is 61.49 lb/ft3. The density of steel is 490 lb/ft3. The factor of wine to steel is 0.1254. Penetration of the wine into the wood layer is, by published research stated to range from 1 mm (0.0394 in.) to 2 mm (0.0788 in.). It takes 11.62 psi to drive the wine 0.0788 in. into and out of white oak.

The interior girth of a 225 L wine barrel is 27.36 in diameter. The density of the wine is 61.49 lb/ft3. The pressure of the wine on the interior wall of the wood barrel is 15.11 psi. That pressure drives the wine 0.1025 in. into the wood.

The density of oxygen is 0.0892 lb/ft3. The density of the wine is 61.49 lb/ft3. The percentage of oxygen to wine is 0.00145. A pressure of 0.16 psi will drive oxygen 0.7635 in. into the wood, the point of interchange of the gas and wine. A pressure of 15.11. psi will drive the wine 0.1025 in. into the wood to the interior side of the stave. A release of 11.62 psi allows the wine to penetrate 0.0788 in. into the wood. A pressure of 11.62 psi drives the wine 0.0788 in. to the interior side of the stave.

The method and apparatus' alteration of the pressure of the cavity by 11.62 psi by a prescribed number of cycles achieves the extraction of the phenols from the wood barrel containing a wine.

The pressure of the cavity of the container may be gradually increased and gradually decreased. That is to say, the gas will be introduced into and removed from the container at a controlled rate such that the rate at which the pressure is increased is slow enough to allow the distilled spirit or wine in the wood barrel to evacuate from and absorb and impregnate the porous structures of the wood. A rapid decrease or increase in pressure of the cavity may result in the distilled spirit collapsing the critical structural and filtration properties of the charcoal layer of a barrel filled with a distilled spirit. A rapid decrease in pressure of the cavity would cause the distilled spirit or wine to penetrate too deep into the porous structures of the wood barrel imparting undesired qualities of the wood into the distilled spirit or wine. Pressurizing the container at too high a value tends to drive the distilled spirit or wine into the interstices between the staves of the wood barrel, thereby causing the barrel to leak. Embodiments herein allow for a sufficient rate for the distilled spirit or wine to evacuate from and absorb and impregnate the porous structures of the wood and the distilled spirit or wine penetrating too deep into the wood.

The pressures of the cavity and the internal pressures of the barrel create a differential pressure (delta P). The change of the differential pressures allows the distilled spirit or wine to absorb into and evacuate from the porous structures of the wood. The precise pressure values and rate is subject to a number of variables including but not limited to the size and composition of the wood barrel, the volume of the distilled spirit or wine in the barrel, the temperature of the container, the density of the distilled spirit or wine, and the depth of the charcoal layer. Hence a range in the pressure, pressurizing rate, and the reduction of pressure rate for a given system is necessary.

In order to stabilize and keep the wood barrel from rolling or shifting in the container, the container preferably includes a support frame and serves to hold the wood barrel in place.

One example of a container is a vessel. Other types of containers may be used, consistent with the spirit of the invention. One example of a standard wood barrel is a 53 gallon whiskey barrel. Other sizes of wood barrels may be used, consistent with the spirit of the invention. One example of a barrel stave thickness is 22 mm (0.866 in). Other sizes of stave thicknesses may be used, consistent with the spirit of the invention. The placement and orientation of the wood barrel's top and bottom may be either on the x axis or the y axis of the container. Stated another way, the barrel may be standing on its bottom or be laying on its side.

### SPECIFIC EXAMPLE

In accordance with one specific embodiment of the invention, an apparatus comprising a container having a total volume of 4,810 cu. in and a gas transfer system as in FIG. 1. was configured and assembled. The gas reservoir of the gas transfer system had a volume of 15 gal. The gas tank of the gas transfer system had of volume of 20 gal. The gas transfer system was connected to a port of the container. The wiring of the valves, pressure transducers, and pumps of the gas transfer system were connected to a programmable logic controller (pie) 300, I/O modules, and 24 v DC power supplies connected to AC power, creating the necessary electronic circuitry for the apparatus to operate. The controller 300 may include a non-transitory machine-readable medium 302 comprising instructions that, when executed, execute a method, such as the method 200 described with reference to FIG. 2. The software of the controller 300 provided for the input of the prescribed pressures, pressurization time, rest time, reduction of pressure time, and cycles into the rungs of the ladder logic. The controller 300 read the ladder logic and performed the instructions of the program.

The specific example applied the surface area to volume ratio 78.7% improvement, reducing the number of cycles from 1,300 to 277. The example applied a 2% deterioration due to the 0.32 psi decrement of the internal barrel pressure of a 53 gallon barrel to a 5 gallon barrel. The specific example applied a 52.17% surface area to volume (sa/v) improvement based on a 69% surface area to volume ratio of a 5 gallon barrel and a 33% surface area to volume ratio of a 53 gallon barrel.

A commercially available 5 gallon white oak whiskey barrel having an exterior volume of 1,839 in3 was manufactured with a Char #3 and a stave thickness of 1.5 in. The wood barrel was filled with 5 gallons of commercially available unaged, 125 proof (62.5 abv) distilled spirit that had been processed with a wheated mash bill. The wood barrel was placed on the support frame inside the container and the container was closed with clamps to ensure a pressure tight seal. The cavity of the container was 2,970. The prescribed values of pressures, pressurization time, rest time, reduction of pressure time, and cycles were entered into the rungs of the ladder logic. The pie program was started.

The air was expelled from the gas reservoir and replaced with gas. The air was removed from the cavity of the container and replaced with gas. The pie initiated a timer for the prescribed 00:23:54 pressurization time. Gas was slowly introduced to the container such that the pressure slowly built up in the cavity at a rate of 0.641 psi/min over the 00:23:54 duration of the pressurization time. The prescribed pressure of 15.33 psi was reached at the prescribed 00:23:54 of pressurization time. The pie initiated a timer for the prescribed 00:02:05 rest time. (A) At the end of the rest time the pie initiated a timer for the prescribed 00:25:08 of release of pressure time. The gas was slowly removed from the container such that the pressure slowly reduced in the cavity at a rate of 0.41 psi/min over the 00:25:08 duration of the release of pressure time. The prescribed pressure of −1.05 psi was reached at the prescribed 00:25:08 of release of pressure time. The pie initiated a timer for the prescribed 00:02:05 rest time. At the end of the rest time the pie initiated a timer for the prescribed 00:23:54 of pressure time. Gas was slowly introduced to the container such that the pressure slowly built up in the cavity at a rate of 0.43 psi/min over the 00:23:54 duration of the pressurization time. The prescribed pressure of 15.33 psi was reached at the prescribed 00:23:54 of pressurization time. The pie initiated a timer for the prescribed 00:02:05 rest time. The pie repeated the respective steps from (A) above for the prescribed 139 cycles over a period of 5.12 days. Ambient pressure of the container was attained, the clamps were released from the container, and the wood barrel was removed.

FIG. 1 is a view of a barrel 101 inside a container 102 having a cavity 103 containing a gas 126. The container having a port 119, a support frame 121 to stabilize the wood barrel 101, and a door 123 with hinges 124 and a handle 125 to allow for the opening and closing and insertion and removal of the wood barrel 101. Connected to the port 119 is a gas transfer system 122 comprising a pressure transducer 106 to measure the pressure of the container 102; a valve 107 connected to port 119 to provide an open or closed path from the container 102; a valve 118 to provide an open or closed path to container 102 connected to the port 119; an air pump 116 connected to valve 118; a valve 115 to expel air from gas reservoir 114 connected to valve 118; an air pump 108 connected to valve 107; a valve 113 connected to air pump 108 to expel air from container 102; a valve 112 connected to air pump 108 to provide an open or closed path from air pump 108; a valve 117 connected to air pump 116 to provide an open or closed path to air pump 116; a valve 110 connected to gas reservoir 114 to provide an open or closed path to or from gas reservoir 114; a pressure transducer 109 to measure the pressure of gas reservoir 114; a gas reservoir 114 connected to valve 110; a valve 104 to provide an open or closed path from gas tank 111; a gas tank 111 connected to valve 104; a gas dryer [symbol] connected to valve 104 to remove moisture in the gas 126; a valve 105 attached to gas tank 111 to open or close gas tank.

The most common char #3 has a charcoal layer depth of 0.1875. Generally, the pressure of the distilled spirit on the interior wall of the wood barrel is 15.33 psi. That pressure may drive the distilled spirit 0.1875 in. from the interior side of the stave into the charcoal layer. The pressure of the distilled spirit at the charcoal and wood interface is 8.93 psi. That pressure may drive the distilled spirit 0.0687 in. into the wood. A pressurization of 0.2586 psi may drive oxygen 1.2437 in. into the wood, the point of interchange of the gas and distilled spirit. A pressurization of 8.93 psi may drive the distilled spirit 0.0678 in. from the exterior side of the stave into the wood to the point of interchange of the wood and charcoal layer. A release of 10.24 psi may allow for the distilled spirit to penetrate back 0.0788 in. from the interchange of the wood and charcoal layer into the wood. A pressurization of 10.24 psi drives the distilled spirit 0.0788 in. to the interchange of the wood and charcoal layer.

For wine barrels, a stave is standard 22 mm (0.866) in depth. The pressure of the wine on the interior wall of the wood barrel is generally 15.11 psi. That pressure may drive wine 0.1025 in. into the wood. A pressurization of 0.16 psi may drive the oxygen 0.7635 in. from the exterior side of the stave into the wood to the point of interchange of the gas and wine. A pressurization of 15.11 psi may drive the wine 0.1025 in. into the wood to the point of interchange of the wood and the interior side of the stave. A release of 11.62 psi may allow for the distilled spirit to penetrate back 0.0788 in. into the wood. A pressurization of 11.62 psi may drive the wine 0.0788 in. to the point of interchange of the wood and the interior side of the stave.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “attachment mechanism” should be understood to encompass disclosure of the act of “attaching”—whether explicitly discussed or not—and, conversely, were there only disclosure of the act of “attaching”, such a disclosure should be understood to encompass disclosure of a “attaching mechanism”. Such changes and alternative terms are to be understood to be explicitly included in the description.

Moreover, the claims shall be construed such that a claim that recites “at least one of A, B, or C” shall read on a device that requires “A” only. The claim shall also read on a device that requires “B” only. The claim shall also read on a device that requires “C” only. The claim shall also read on a device that requires “A+B”. The claim shall also read on a device that requires “A+B+C”, and so forth.

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

1. A system for aging an alcoholic beverage, comprising:
a first housing having an interior and an exterior;
a second housing holding a liquid therein, the second housing having a wooden wall and positioned inside the first housing;
a gas transfer system fluidly coupled to the interior of the first housing, the gas transfer system having a controller comprising instructions that, when executed by one or more processors, cause the gas transfer system to execute a method, the method comprising:
(A) execute a complete pressurization cycle, the complete pressurization cycle comprising
(i) causing a gas within the gas transfer system to pressurize the interior of the first housing to a first pressure for a first period of time, and,
(ii) after the first period of time, causing the gas to pressurize the interior of the first housing to a second pressure less than the first pressure for a second period of time; and
(B) repeat the complete pressurization cycle a plurality of times; wherein
the first pressure is 15.7 psi or less;
the gas comprises at least 21.1 percent oxygen by volume; and wherein
the second pressure is at least 4 psi less than the first pressure; whereby
the liquid is aged into an alcoholic beverage.

2. The system of claim 1, wherein:
the first pressure is 14.9 psi or less.

3. The system of claim 2, wherein:
the first pressure is 12 psi or less.

4. The system of claim 2, wherein:
the first pressure is 10 psi or less.

5. The system of claim 2, wherein:
the first pressure is 8 psi or less.

6. The system of claim 1, wherein:
the second pressure is at least 10 psi less than the first pressure.

7. The system of claim 1, wherein:
the second pressure is about 0 psig.

8. The system of claim 1, wherein:
the gas comprises at least 30 percent oxygen gas by volume.

9. The system of claim 8, wherein:
the gas comprises at least 50 percent oxygen gas by volume.

10. The system of claim 9, wherein:
the gas comprises at least 70 percent oxygen gas by volume.

11. The system of claim 10, wherein:
the gas comprises at least 90 percent oxygen gas by volume.

12. The system of claim 11, wherein:
the gas comprises at least 95 percent oxygen gas by volume.

13. The system of claim 12, wherein:
the gas comprises substantially 100 percent oxygen gas by volume.

14. The system of claim 1,
further comprising a user interface; and wherein the method comprises, responsive to a user input indicative of at least one of a wood species or a wood hardness, determine the first pressure and the second pressure, wherein the first pressure and the second pressure are selected based on the wood species elected.

15. The system of claim 1, wherein:
the first period of time is between 12 minutes and 30 minutes; and
the second period of time is between 2 minutes and 10 minutes.

16. The system of claim 15, wherein:
the complete pressurization cycle is completed in less than 2 hours.

17. The system of claim 16, wherein:
the complete pressurization cycle is completed in less than 90 minutes.

18. The system of claim 15, wherein:
the complete pressurization cycle is completed in no less than 1 hour.

19. The system of claim 1, wherein:
the complete pressurization cycle is repeated at least 1,300 times in 4 months or less.

20. The system of claim 1, wherein:
the complete pressurization cycle is repeated at least 50,000 times in 9 years or less.

21. The system of claim 1, wherein:
the complete pressurization cycle further comprises, between the first period of time and the second period of time, a third period of time wherein the first pressure is substantially constant;
the complete pressurization cycle further comprises, after the second period of time, a fourth period of time wherein the second pressure is substantially constant; and wherein
the third period of time is 30 minutes or less; and
the fourth period of time is 10 minutes or less.

22. The system of claim 21, wherein:
the third period of time is 20 minutes or less; and
the fourth period of time is 6 minutes or less.

23. A method of aging an alcoholic beverage, comprising:
placing a wooden barrel containing a liquid inside a chamber having a gas therein;
causing the gas to undergo a complete pressurization cycle, the complete pressurization cycle comprising
(i) a first pressure for a first period of time, and,
(ii) after the first period of time, a second pressure less than the first pressure for a second period of time; and
causing the gas to repeat the complete pressurization cycle a plurality of times; wherein
the first pressure is 15.7 psi or less;
the gas comprises at least 21.1 percent oxygen by volume; and wherein
the second pressure is at least 0 psi and is between 4 psi and 12 psi less than the first pressure; whereby
the liquid is aged into a desired alcoholic beverage in a period of time that is at least 50% less than a time prescribed by The Federal Standards of Identity for Distilled Spirits for the desired alcoholic beverage; and
the liquid is aged into a desired alcoholic beverage in a period of time that is at least 75% less than the time prescribed by The Federal Standards of Identity for Distilled Spirits for the desired alcoholic beverage.
